(19) United States
(12) Patent Application Publication
(10) Pub. No.: US 2024/0302197 A1
(43) Pub. Date: Sep. 12, 2024

(54) WORK VEHICLE AND METHOD FOR DETECTING LIQUID REPLENISHMENT OF WORK VEHICLE

(71) Applicant: KUBOTA CORPORATION, Osaka-shi (JP)

(72) Inventors: Tomoyuki NOGUCHI, Sakai-shi (JP); Fumiya KOZONO, Sakai-shi (JP)

(73) Assignee: KUBOTA CORPORATION, Osaka-shi (JP)

(21) Appl. No.: 18/592,527

(22) Filed: Mar. 1, 2024

(30) Foreign Application Priority Data
Mar. 6, 2023 (JP) 2023-033881

(51) Int. Cl. G01F 23/20; G01F 23/80

(52) U.S. Cl. CPC G01F 23/205; G01F 23/802

(57) ABSTRACT

A work vehicle includes a tank, a liquid amount detection sensor, a speaker, and circuitry. The tank is configured to store a liquid. The liquid amount detection sensor is provided in the tank and is configured to measure the amount of liquid in the tank. The speaker is configured to output a notification sound. The circuitry is configured to control the speaker to output the notification sound when the amount of liquid per unit time detected by the liquid amount detection sensor increases. The circuitry is configured to stop outputting the notification sound when the amount of liquid per unit time detected by the liquid amount detection sensor does not increase.

### CROSS-REFERENCE TO RELATED APPLICATIONS

The present application claims priority under 35 U.S.C. § 119 to Japanese Patent Application No. 2023-033881, filed Mar. 6, 2023. The contents of this application are incorporated herein by reference in their entirety.

### BACKGROUND OF THE INVENTION

### Field of the Invention

The present invention relates to a work vehicle and a method for detecting a liquid replenishment of a work vehicle.

### Discussion of The Background

U.S. Pat. No. 9,815,332 describes a work vehicle transmits the remaining amount of a fuel or a urea aqueous to a user by a buzzer sound and/or lighting of a predetermined button.

### SUMMARY OF THE INVENTION

According to one aspect of the present disclosure, a work vehicle includes a tank, liquid amount detection censor, a speaker, and circuitry. The tank is configured to store a liquid. The liquid amount detection sensor is provided in the tank and is configured to measure an amount of liquid in the tank. The speaker is configured to output a notification sound. The circuitry is configured to control the speaker to output the notification sound when the amount of liquid per unit time detected by the liquid amount detection sensor increases, the circuitry being configured to control the speaker to stop outputting the notification sound when the amount of the liquid per unit time detected by the liquid amount detection sensor does not increase.

According to a second aspect of the present disclosure, a work vehicle includes a tank, an additional tank, a liquid amount detection sensor, an additional liquid amount detection sensor, a speaker, and circuitry. The tank is configured to store a liquid. The additional tank is configured to store an additional liquid different from the liquid. The liquid amount detection sensor is provided in the tank and configured to measure the amount of liquid in the tank. The additional liquid amount detection sensor is provided in the additional tank and configured to measure the amount of liquid in the tank. The speaker is configured to output the notification sound and an additional notification sound the circuitry being configured to control in one of characteristics of a frequency spectrum in an audible range and an output interval at which each of the notification sound and the additional notification sound is intermittently. The circuitry is configured to control the speaker to output the notification sound in accordance with the amount of the liquid and to control the speaker to output the additional notification sound in accordance with the amount of the additional liquid.

According to a third aspect of the present disclosure, a method for detecting liquid replenishment of the work vehicle includes measuring an amount of a liquid in a tank, outputting a notification sound when the amount of the liquid per unit time increases, and stopping the output of the notification sound when the amount of the liquid per unit time does not increase.

### BRIEF DESCRIPTION OF THE DRAWINGS

A more complete appreciation of the present disclosure and many of the at tendant advantages thereof will be readily obtained as the same becomes better unders tood by reference to the following detailed description when considered in connection with the accompanying drawings.

FIG. 1 is a side view of a work vehicle.

FIG. 2 is a top view of the work vehicle.

FIG. 3 is a block diagram of the work vehicle.

FIG. 4 is a diagram showing an example of a mode in which an amount of a fuel and an amount of a urea aqueous can be distinguished only by the output interval of a fuel replenishing notification sound and the output interval of a urea aqueous replenishing sound.

FIG. 5 is a diagram showing an example of a mode in which the fuel replenishing notification sound and the urea aqueous replenishing notification sound are distinguished from each other at intervals of outputting sounds, and the frequency spectrum of the audible range is changed according to the remaining amount.

FIG. 6 is a diagram showing a case where the frequency spectrum of the audible range of the fuel replenishing notification sound and the frequency spectrum of the audible range of the urea aqueous replenishing notification sound are different from each other, and the interval of outputting the sounds is changed in accordance with the frequency spectrum of the fuel replenishing notification sound, the urea aqueous replenishing notification sound, and the remaining amount.

FIG. 7 is a diagram showing a screen of a display.

FIG. 8 is a flowchart showing the operation of the controller of the work vehicle according to the embodiment.

### DESCRIPTION OF THE EMBODIMENTS

The present invention will be described in detail below with reference to the drawings showing embodiments thereof. In the description, the same elements and elements having the same function are denoted by the same reference numerals, and duplicated description is omitted.

### FIRST EMBODIMENT

### Overall Configuration

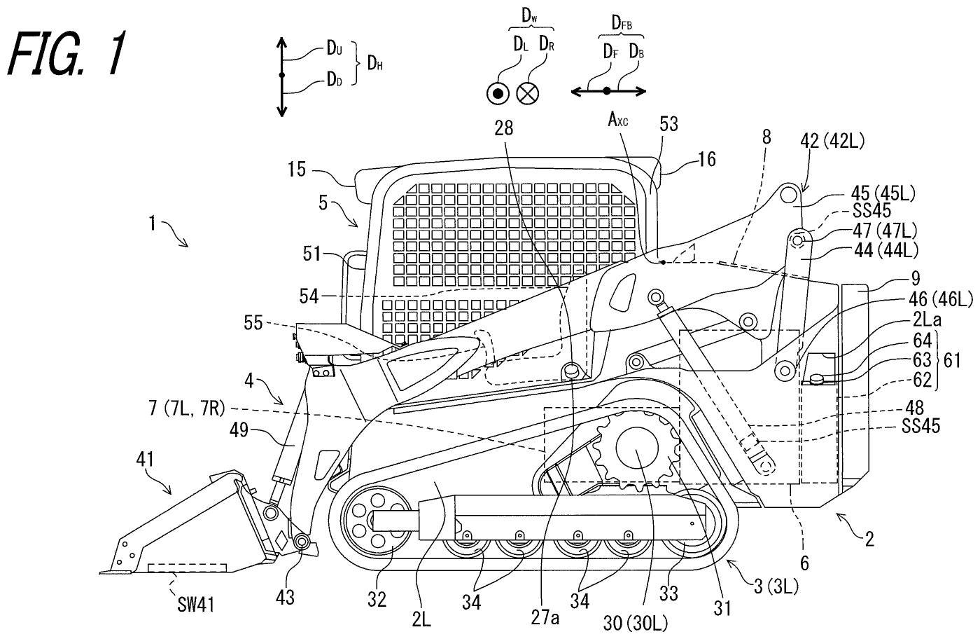

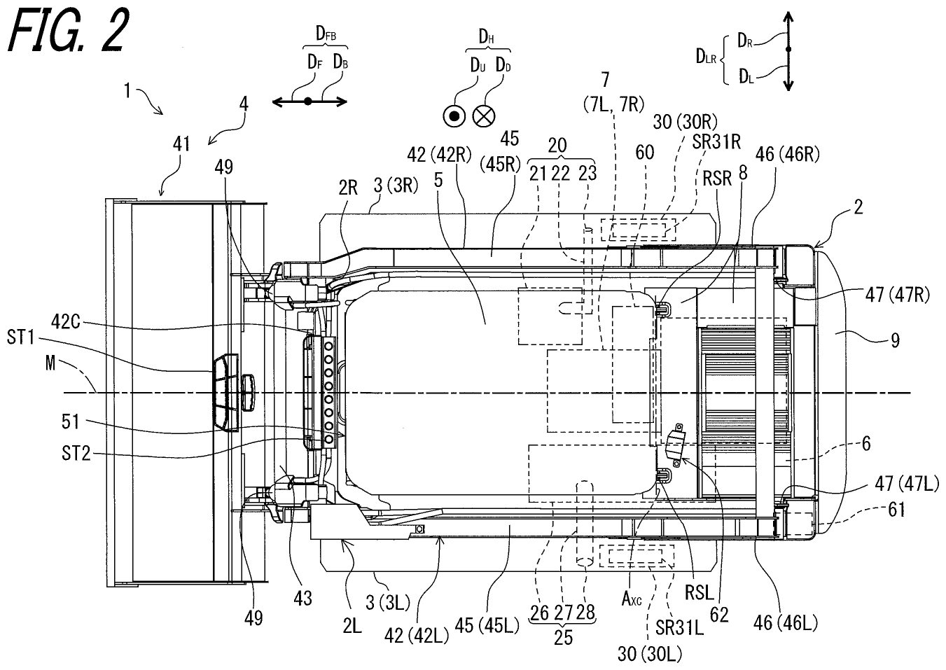

Referring to FIGS. 1 and 2, a work vehicle 1, for example, a compact truck loader, includes a vehicle body 2, a pair of traveling devices 3, and a work device 4. The vehicle body 2 supports the traveling device 3 and the work device 4. In the illustrated embodiment, the traveling device 3 is a crawler type traveling device. Therefore, each of the pair of traveling devices 3 includes a drive wheel 31, driven wheels 32 and 33, and a rolling wheel 34, which are driven by the hydraulic motor device 30. However, each of the pair of traveling devices 3 is not limited to the crawler type traveling device. Each of the pair of traveling devices 3 may be, for example, a front wheel/rear wheel traveling device or a traveling device having a front wheel and a rear crawler. The work device 4 comprises work equipment (bucket) 41 at the distal end of the work device 4. A proximal end of the work device 4 is attached to a rear portion of the vehicle body 2. The work device 4 includes a pair of arm assemblies 42 for rotatably supporting the bucket 41 via a bucket pivot shaft 43. Each of the pair of arm assemblies 42 includes a link 44 and a pair of arms 45.

The link 44 is rotatable relative to the vehicle body 2 about a fulcrum shaft 46. The arm 45 is rotatable relative to the link 44 about a joint shaft 47. The work device 4 further includes a plurality of arm cylinders 48 and at least one equipment cylinder 49. Each of the plurality of arm cylinders 48 is rotatably connected to the vehicle body 2 and the arm 45, and moves the link 44, the arm 45, and the like to raise and lower the bucket 41. The at least one implement cylinder 49 is configured to tilt the bucket 41. The vehicle body 2 includes a cabin 5. The cabin 5 includes a front window 51 that can be opened and closed, and the outer shape of the cabin 5 is defined by a cab frame 53. The front window 51 may be omitted. The work vehicle 1 includes a driver's seat 54 and an operation lever 55 in the cabin 5. As shown in FIG. 2, the cab frame 53 is rotatable around rotational shafts RSL and RSR on the vehicle body 2. In FIGS. 1 and 2, the rotational shafts RSL and RSR are parallel to each other. The common pivot AXC is defined by the following equation: That is, the cab frame 53 is attached to the vehicle body 2 so as to be rotatable around the pivot AXC.

In the embodiment according to the present application, a front-back direction D_{FB} (forward direction D_{F}/backward direction D_{B}) means a front-back direction (forward direction/backward direction) as seen from an operator seated on the driver's seat 54 of the cabin 5. A leftward direction D_{L}, a rightward direction D_{R}, a width direction D_{W} means the left direction, the right direction, and the left-right direction as viewed from the operator, respectively. An upward direction D_{U}, a downward direction D_{D}, height direction D_{H} means an upward direction, a downward direction, and a height direction as viewed from the operator. The height direction D_{H} is along the height of the work vehicle 1. The front-back, left-right (width), and up-down (height) directions of the work vehicle 1 coincide with the front-back, left-right (width), and up-down (height) directions as viewed from the operator, respectively.

FIG. 1 shows the left side of the work vehicle 1. As shown in FIG. 2, the vehicle body 2 is substantially symmetrical with respect to the vehicle body center plane M and includes a first side surface 2L which is a left side and a second side surface 2R which is a right side. Among the pair of traveling devices 3, the traveling device 3 provided on the first side surface 2L is shown as a first traveling device 3L, and the traveling device 3 provided on the second side surface 2R is shown as a second traveling device 3R. Among the pair of arm assemblies 42, the arm assembly 42 provided on the left side with respect to the vehicle body center plane is shown as a first arm assembly 42L, and the arm assembly 42 provided on the right side with respect to the vehicle body center plane M is shown as a second arm assembly 42R. The link 44 provided on the left side of the vehicle body center plane M is shown as a first link 44L. An arm 45 provided on the left side of the vehicle body center plane M is shown as a first arm 45L, and the arm 45 provided on the right side of the vehicle body center plane M is shown as a second arm 45R. The fulcrum shaft 46 provided on the left side with respect to the vehicle body center plane M is shown as a first fulcrum shaft 46L, a fulcrum shaft 46 provided on the right side with respect to the vehicle body center plane M is shown as a second fulcrum shaft 46R. A joint shaft 47 provided on the left side with respect to the vehicle body center plane M is shown as a first joint shaft 47L, and a joint shaft 47 provided on the right side with respect to the vehicle body center plane M is shown as a second joint shaft 47R. Among the hydraulic motor devices 30, the hydraulic motor device 30 provided on the left side with respect to the vehicle body center plane M is indicated as the first hydraulic motor device 30, the hydraulic motor device 30 provided on the right side with respect to the vehicle body center plane M is indicated by as a second hydraulic motor device 30R.

Referring to FIGS. 1 and 2, the work vehicle 1 further includes an engine 6 provided at a rear portion of a vehicle body 2 and a plurality of hydraulic pumps 7 including the first hydraulic pump7L and second hydraulic pump 7R. The engine 6 drives the plurality of hydraulic pumps 7. The first hydraulic pump 7L and the second hydraulic pump 7R are configured to discharge the hydraulic fluid for driving the hydraulic motor device 30 and the like that drive the drive wheels 31. The plurality of hydraulic pumps 7 other than the first hydraulic pump 7L and the second hydraulic pump 7R are configured to discharge hydraulic fluid for driving hydraulic actuators (the plurality of arm cylinders 48, at least one instrument cylinder 49, and the like) connected to the work device 4. The engine 6 is provided between the pair of arm assemblies 42 in the width direction D_{W} of the work vehicle 1. The work vehicle 1 further includes a cover 8 for covering the engine 6. The work vehicle 1 further includes a bonnet cover 9 provided at the rear end of the vehicle body 2. The bonnet cover 9 can be opened and closed, and a maintenance worker can perform maintenance work of the engine 6 and the like.

A hydraulic oil tank 20 and a fuel tank 25 are mounted on the left and right of the plurality of hydraulic pumps 7. The hydraulic oil tank 20 is a tank for storing hydraulic oil for operating the hydraulic actuators described above, and is provided on the right side of the plurality of hydraulic pumps 7. The hydraulic oil tank 20 includes a hydraulic oil tank body 21, a supply pipe 22, and a cap 23. The fuel tank 25 is a tank that stores fuel for the engine 6, and is provided on the left side of the plurality of hydraulic pumps 7. The fuel tank 25 extends forward from the left side of the front portion of the engine 6. The fuel tank 25 includes a fuel-tank main body 26, a fuel replenishing pipe 27, and a cap 28. The fuel-tank main body 26 is configured to store fuel. The fuel replenishing pipe 27 extends upward and leftward from a longitudinally intermediate portion in a front/back direction of the upper surface of the fuel-tank main body 26. As shown in FIG. 1, the supply port 27a of the fuel replenishing pipe 27 is located above the first side surface 2L of the vehicle body 2. Fuel is supplied from the supply port 27a. The supply port 27a is closed by a cap 28 to be openable and closable.

The work vehicle 1 further includes a diesel particulate filter (not illustrated), a selective catalytic reduction catalyst 60, and a urea aqueous tank 61. The diesel particulate filter removes particulates in the exhaust from the engine 6. The selective catalytic reduction catalyst 60 is connected to an exhaust port of the engine 6 via a diesel particulate filter, and reduces nitrogen oxides in the exhaust gas from the engine 6. This reduction reaction is performed by the reaction between the ammonia gas obtained by hydrolyzing the urea aqueous stored in the urea aqueous tank 61 by the heated exhaust gas of the engine 6 and the nitrogen oxides in the exhaust gas. The urea aqueous tank 61 is located at a rear end portion of the vehicle body 2 and is located rearward and rightward of the engine 6. As shown in FIG. 1, the urea aqueous tank 61 is located below the first arm assembly 42L. The urea aqueous tank 61 includes a urea aqueous tank main body 62, a supply port 63, and a cap 64. The urea aqueous tank main body 62 is configured to store urea aqueous. The supply port 63 is provided on the upper surface of the urea aqueous tank main body 62. The urea aqueous is supplied from the supply port 63. The supply port 63 is closed by a cap 64 to be openable. The first side surface 2L of the vehicle body 2 is provided with an opening 2La for accessing the supply port 63 and the cap 64 from the outside of the car.

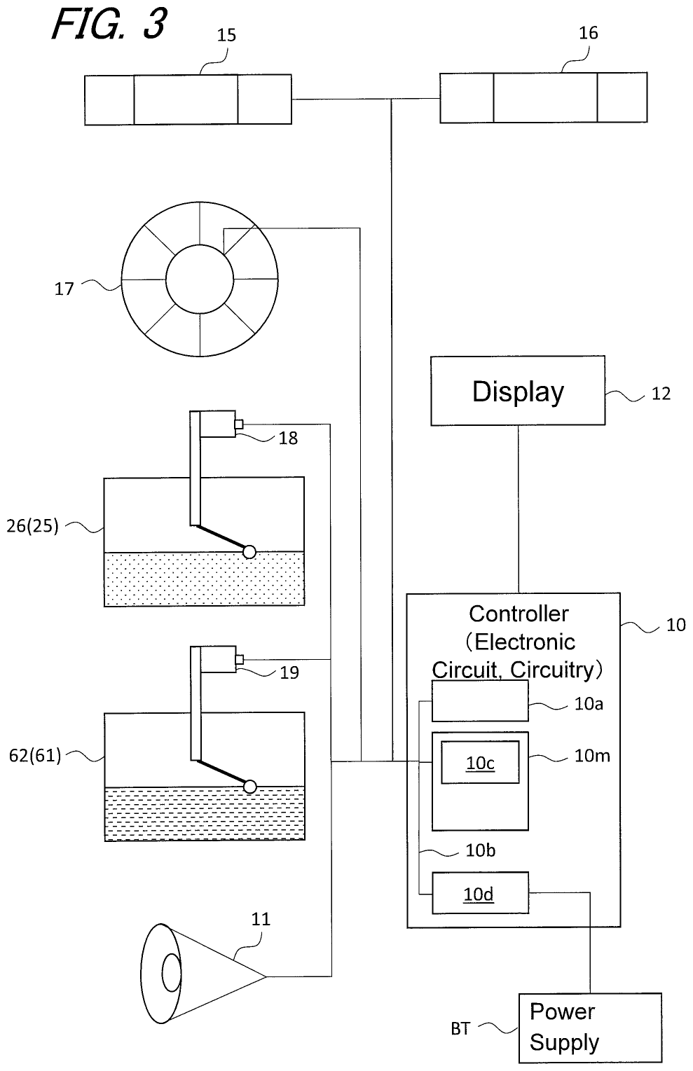

FIG. 3 is a block diagram of the work vehicle 1. Referring to FIG. 3, the work vehicle 1 further includes a power supply BT, a controller 10, a speaker 11, a display 12, and a headlight 15; a rear light 16, a switch 17, a fuel amount detection sensor 18, and a urea aqueous amount detection sensor 19. The fuel amount detection sensor 18 is provided in the fuel tank 25 and is configured to measure the amount of fuel in the fuel tank 25. The fuel amount detection sensor 18 is preferably a liquid amount detection sensor that measures the liquid level of the liquid in the fuel tank 25. However, the fuel amount detection sensor 18 may be a weight sensor.

The urea aqueous amount detection sensor 19 is provided in the urea aqueous tank 61 and is configured to measure the amount of urea aqueous in the urea aqueous tank 61. The urea aqueous amount detection sensor 19 is preferably a liquid level sensor that measures the liquid level of the liquid in the urea aqueous tank 61. However, the urea aqueous amount detection sensor 19 may be a weight sensor. The speaker 11 is configured to output a fuel replenishing notification sound and a urea aqueous replenishing notification sound that is different from the fuel replenishing notification sound. Here, the different sounds mean that the characteristics of the sounds are different in either the frequency spectrum of the audible range or the output interval of the intermittently emitted sounds. The audible range indicates frequencies in 20 hz to 20 khz, for example. The intermittent sound generation means that the output and non-output of the sound are switched at a frequency of 20 times or less per second. In the following embodiments, one of the fuel replenishing notification sound and the urea aqueous replenishing notification sound may be simply referred to as the notification sound, and the other may be referred to as the additional notification sound. Further, the notification sound is simply displayed.

The controller 10 is configured to receive the output of the fuel amount detection sensor 18, and to control the speaker 11 to output the fuel replenishing notification sound when the amount of fuel per unit time detected by the fuel amount detection sensor 18 increases, and to stop the output of the fuel replenishing notification sound when the amount of fuel per unit time detected by the fuel amount detection sensor 18 does not increase. The controller 10 is configured to receive the output of the urea aqueous amount detection sensor 19, and to control the speaker 11 to output the urea aqueous replenishing notification sound when the amount of urea aqueous per unit time detected by the urea aqueous amount detection sensor 19 increases, and control the speaker 11 to stop the output of the urea aqueous replenishing notification sound when the amount of urea aqueous per unit time detected by the urea aqueous amount detection sensor 19 does not increase.

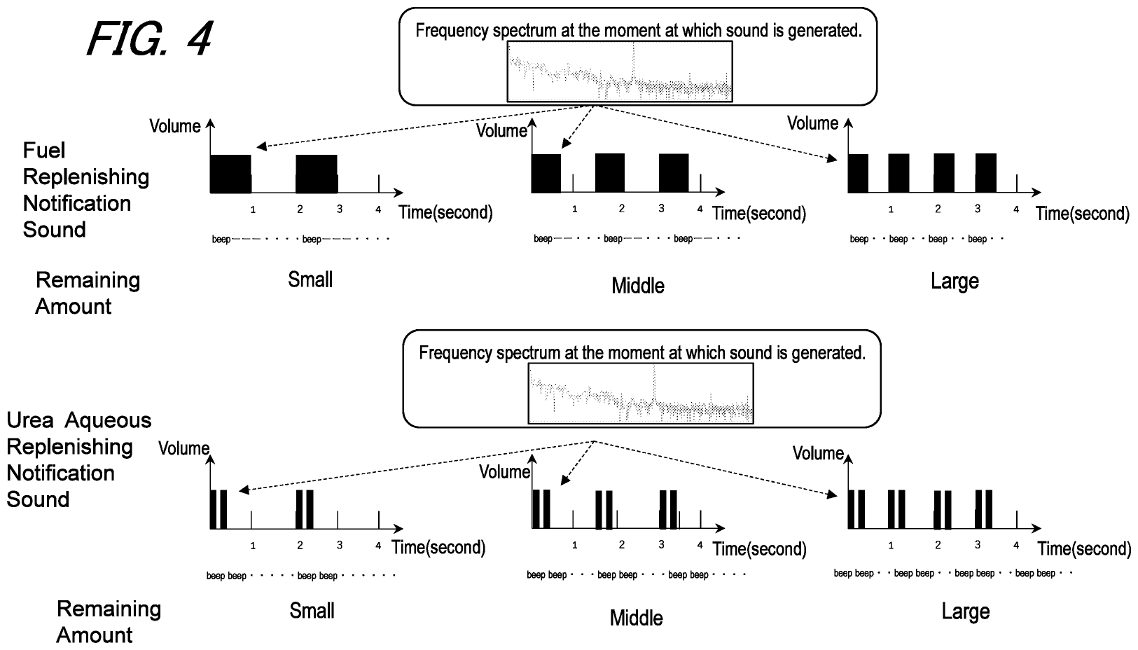

The controller 10 changes a first characteristic of the fuel replenishing notification sound in accordance with the amount of fuel. The controller 10 changes the first characteristic of the urea aqueous replenishing notification sound according to the amount of urea aqueous. The first characteristic is one of the frequency spectrum in audible range and the output interval at which each of the warning sound and the notification sound is intermittently emitted. The fuel replenishing notification sound and the urea aqueous replenishing notification sound are different in the second characteristic of sound. The second characteristic is also one of the frequency spectrum in audible range and the output interval of the sound intermittently emitted. Note that the first characteristic and the second characteristic are different to the extent that a person can distinguish them from other sounds. FIG. 4 shows an example of sound output in a case where both the first characteristic and the second characteristic are sound output intervals.

FIG. 4 shows an example of the mode in which the amount of fuel and the amount of urea aqueous can be distinguished only by the output interval of the fuel replenishing notification sound and the output interval of the urea aqueous replenishing notification sound. In the example of FIG. 4, the fuel replenishing notification sound having the same frequency spectrum is continuously outputted in the audible range, whereas the urea aqueous replenishing notification sound is outputted and not outputted at intervals of 0.1 seconds, so that the sounds can be distinguished from each other. Both the fuel replenishing notification sound and the urea aqueous replenishing notification sound are generated at intervals of two seconds when the remaining amount is small, at intervals of 1.33 seconds when the remaining amount is medium, and at intervals of one second when the remaining amount is large. These time intervals are merely examples, and other time intervals may be used. In this way, in the audible range, even if the sound has the same frequency spectrum, the sound is output at different time intervals, so that the fuel and the urea aqueous can be distinguished and the respective amounts can be identified.

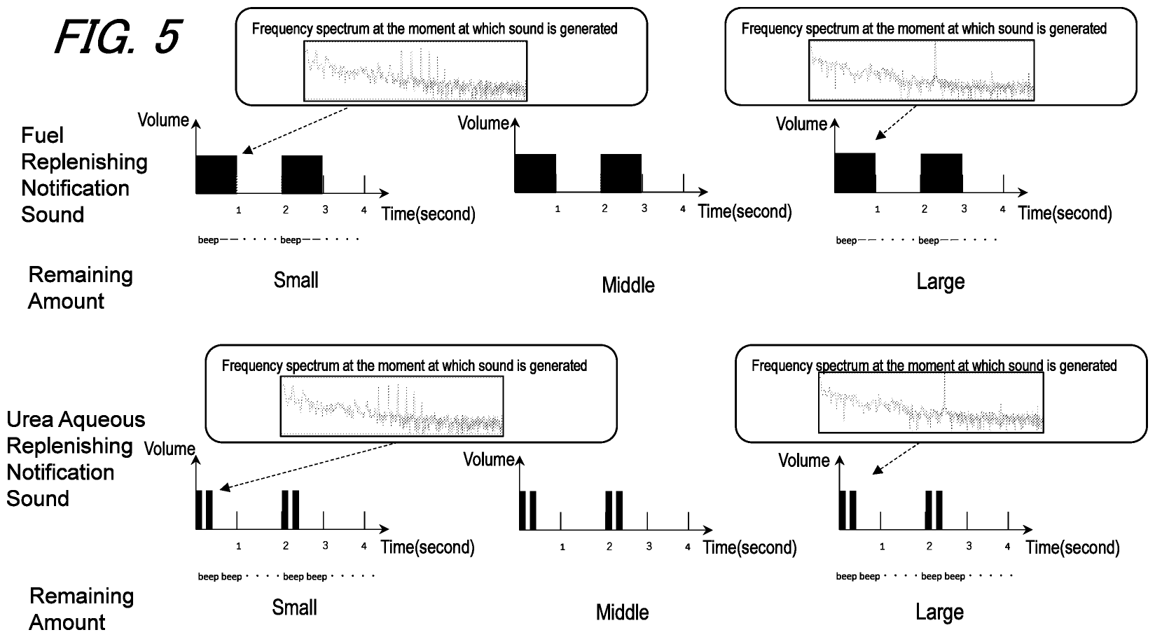

In another embodiment, the fuel replenishing notification sound and the urea aqueous replenishing notification sound are distinguished from each other at intervals of outputting the sounds, and the frequency spectrum of the audible range of the sounds is changed according to the remaining amount. FIG. 5 shows an example of such a mode. In the example of FIG. 5, the tone is raised as the amount of liquid increases, that is, the level of a high frequency is raised. In the example of FIG. 5, the fuel replenishing notification sound is outputted at intervals of one second, whereas the urea aqueous replenishing notification sound is outputted, not outputted, and outputted at intervals of 0.1 second, so that the respective sounds can be identified. Note that this time interval is merely an example, and may be another time interval.

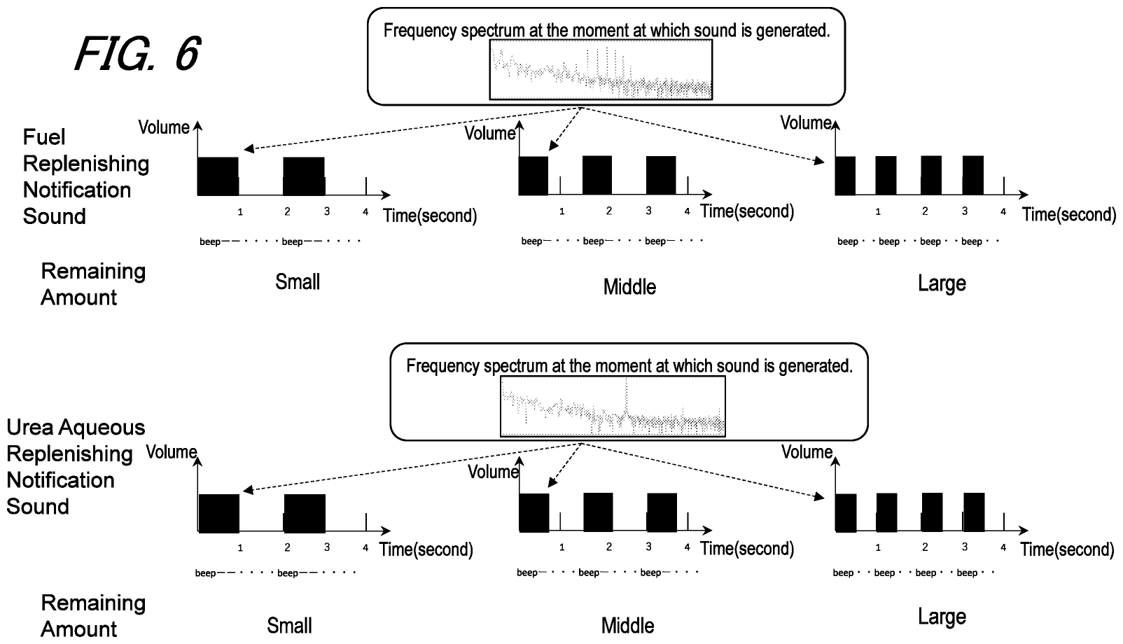

In a preferred embodiment, the frequency spectrum of the audible range of the fuel replenishing notification sound and the frequency spectrum of the audible range of the urea aqueous replenishing notification sound are different from each other, and the interval of outputting the sounds is changed in accordance with the frequency spectrum of the fuel replenishing notification sound, the urea aqueous replenishing notification sound, and the remaining amount. FIG. 6 shows an example of such a mode. In the example of FIG. 6, both the fuel replenishing notification sound and the urea aqueous replenishing notification sound are generated continuously for one second at intervals of two seconds when the remaining amount is small, are generated continuously for 0.67 seconds at intervals of 1.33 seconds when the remaining amount is medium, and are generated continuously for 0.5 seconds at intervals of one second when the remaining amount is large. Note that this time interval is merely an example, and may be another time interval. Further, it is desirable to use a sound generally used as a buzzer sound for both the fuel replenishing notification sound and the urea aqueous replenishing notification sound.

When the fuel level exceeds a predetermined value (for example, 100% level near full tank), the fuel warning sound which is different from the fuel replenishing notification sound in the first characteristic or a second characteristic that is different from the first characteristic is emitted. When the level of the urea aqueous exceeds a predetermined threshold value (for example, 100% level near full tank), the urea aqueous warning sound having the first characteristic or the second characteristic different from the urea aqueous replenishing notification sound is emitted. As a typical example, the fuel warning sound may be emitted by continuously outputting the fuel replenishing notification sound for a certain time (for example, 5 seconds). Alternatively, the fuel warning sound may be emitted by continuously outputting a sound that is different only in loudness level from the fuel replenishing notification sound (that is, only the height of the level is changed without changing the relative height of the level of each of the frequencies). The urea aqueous warning sound may be emitted by continuously outputting the urea aqueous replenishing notification sound for a certain time (for example, 5 seconds). Alternatively, the urea aqueous warning sound may be emitted by continuously outputting a sound different only in loudness level from the urea aqueous replenishing notification sound. Alternatively, the fuel warning sound and the urea-water warning sound may be buzzer sounds different from the fuel replenishing notification sound and the urea aqueous replenishing notification sound.

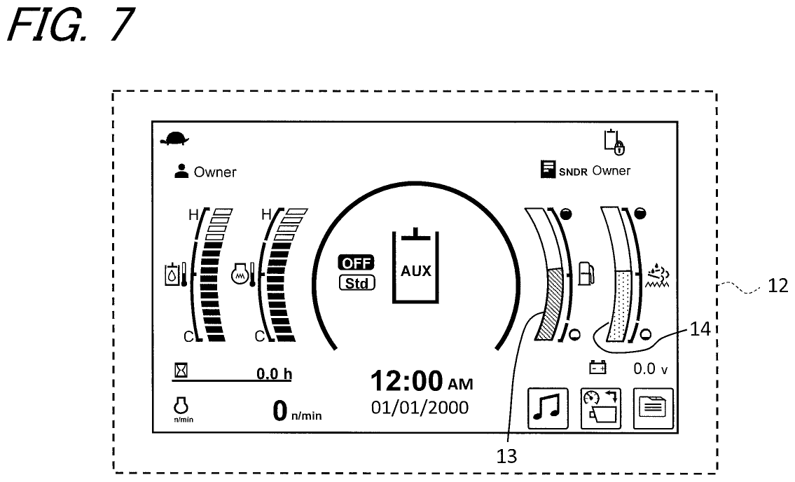

FIG. 7 is a diagram showing a screen of the display 12. As shown in FIG. 7, the display 12 is configured to display a fuel indicator 13 indicating the amount of fuel and a urea aqueous indicator 14 indicating the amount of urea aqueous. The controller 10 is configured to control the display 12 to blink the fuel indicator 13 when the amount of fuel per unit time increases, and control the display 12 to stop blinking the fuel indicator 13 when the amount of fuel per unit time does not increase. Preferably, the controller 10 shortens the interval at which the fuel indicator 13 illuminates as the amount of fuel increases, as in the case of the fuel replenishing notification sound described above. The controller 10 is configured to control the display 12 to blink the urea aqueous indicator 14 when the amount of urea aqueous per unit time increases, and control the display 12 to stop blinking the urea aqueous indicator 14 when the amount of urea aqueous per unit time does not increase. Preferably, the controller 10 shortens the interval at which the urea aqueous indicator 14 illuminates as the amount of urea aqueous increases, as in the case of the urea aqueous replenishing notification sound described above.

The headlight 15 and the rear light 16 are configured to illuminate the surroundings of the work vehicle 1. More specifically, the headlight 15 is configured to illuminate the front of the work vehicle 1. The rear light 16 is configured to illuminate the rear of the work vehicle 1. When the amount of fuel per unit time is increasing, the controller 10 is configured to blink one of the headlight 15 and the rear light 16, and to stop blinking one of the headlight 15 and the rear light 16 when the amount of fuel per unit time does not increase. Preferably, the controller 10 shortens the interval at which one of the headlight 15 and the rear light 16 is turned on as the amount of fuel increases, as in the case of the fuel replenishing notification sound described above. The controller 10 is configured to blink the other of the headlight 15 and the rear light 16 when the amount of urea aqueous per unit time increases, and to stop blinking the other of the headlight 15 and the rear light 16 when the amount of urea aqueous per unit time does not increase. Preferably, the controller 10 shortens the interval at which the other of the headlight 15 and the rear light 16 is turned on as the amount of urea aqueous increases, similarly to the urea aqueous replenishing notification sound described above.

In the following embodiments, one of the fuel tank 25 and the urea aqueous tank 61 may be referred to as a tank, and the other may be referred to as an additional tank. Among the fuel and the urea aqueous, the liquid stored in the tank may be simply referred to as the liquid, and the liquid stored in the additional tank may be referred to as the additional liquid. Among the fuel amount detection sensor 18 and the urea aqueous amount detection sensor 19, the sensor that detects the liquid amount in the tank may be referred to as a liquid amount detection sensor, and the sensor that detects the liquid amount in the additional tank may be referred to as an additional liquid amount detection sensor.

Among the fuel replenishing notification sound and the urea aqueous replenishing notification sound, the notification sound whose output is changed according to the liquid amount detected by the liquid amount detection sensor may be simply referred to as the notification sound, and the notification sound whose output is changed according to the liquid amount detected by the additional liquid amount detection sensor may be referred to as the additional notification sound. Among the fuel warning sound and the urea aqueous warning sound, the warning sound indicating that the tank is nearly full may be simply referred to as a warning sound, and the warning sound indicating that the additional tank is full may be referred to as an additional warning sound.

Further, among the fuel indicator 13 and the urea aqueous indicator 14, the indicator for indicating the liquid amount in the tank may be simply referred to as the indicator, and the indicator for indicating the liquid amount in the additional tank may be referred to as the additional indicator. Among the light of the headlight 15 and the rear light 16, a light that is blinked when the liquid amount of the tank is increasing may be referred to as a working light, and a light that is blinked when the liquid amount of the additional tank is increasing may be referred to as an additional working light.

The controller 10 is formed of an ECU (Electric Control Unit). The controller 10 includes a processor 10a, a memory 10m, and a bus 10b as illustrated in FIG. 3 in order to realize the above-described processing. The memory 10m includes volatile memory and non-volatile memory. The memory 10m includes a notification program 10c (not illustrated) for realizing the above-described control. The processor 10a executes the above-described control while executing the notification program 10c. The bus 10b connects the processor 10a and the memory 10m. The processor 10a, the memory 10m, and the bus 10b are electronic circuits (circuitry). The bus 10b is connected to the speaker 11, the headlight 15, the rear light 16, the switch 17, the fuel amount detection sensor 18, and the aqueous-of-urea amount detection sensor 19 via a known external interface (such as a universal serial bus (USB) or a remote control system (RS-232C) (not illustrated).

The controller 10 further includes a switch circuit (switching circuitry) 10d. The switch circuit 10d is configured to switch on the circuitry by connecting the power supply to the circuitry and to switch off the circuitry by disconnecting the power supply from the electronic circuit. That is, the power supply BT is configured to supply electricity to the electronic circuit described above. Hereinafter, a state where the switch circuit 10d supplies electricity from the power supply BT to the electronic circuit is referred to as a power-on state, and a state where the switch circuit 10d does not supply electricity from the power supply BT to the electronic circuit is referred to as a power-off state. The switch circuit 10d is connected to the switch 17 via the bus 10b. When the switch 17 is pressed in the power-off state, the switch circuit 10d switches to the power-on state. When the switch 17 is depressed in the power-on state, the controller 10 displays a confirmation prompt of power-off on the display 12, and when an operation button or the like such as the switch 17 is operated, the switch circuit 10d is switched to the power-off state. Note that the confirmation prompt may be omitted, and the controller 10 may immediately switch to the power-off state when the switch 17 is pressed in the power-on state. Further, the processor 10a (a part of the electronic circuit) is configured to send a signal for switching the switch circuit 10d so as not to supply electricity when a predetermined time elapses from a state where the amount of liquid does not increase. The predetermined time is, for example, 10 minutes.

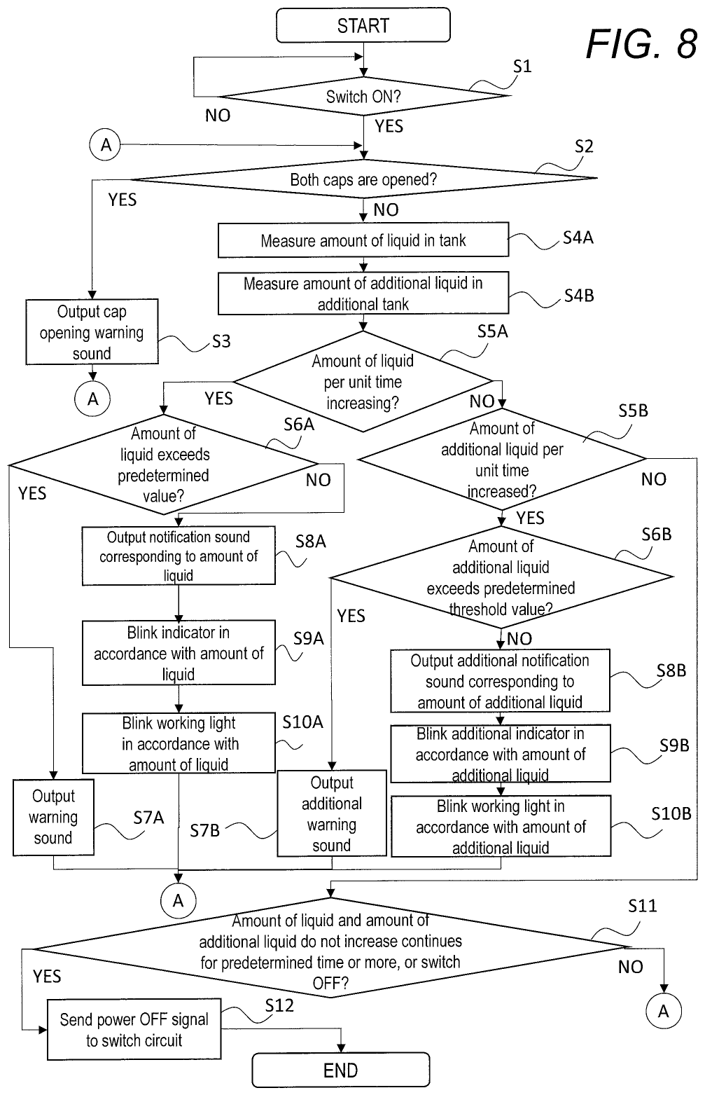

FIG. 8 is a flowchart showing the operation of the controller 10 of the work vehicle 1. In step S1, the switch circuit 10d of the controller 10 detects that the switch 17 is pressed, and switches the power supply to the ON state. As a result, electricity is supplied to the processor 10a and the memory 10m, and the notification program 10c is activated. In step S2, the processor 10a executing the notification program 10c determines whether both the cap 28 and the cap 64 are opened based on a signal from a sensor attached to the supply port 27a and/or the cap 28, the supply port 63 and/or the cap 64 (for example, a sensor that detects opening and closing of the cap based on electrical contact between the supply port and the cap). When both the cap 28 and the cap 64 are opened (Yes in step S2), the processor 10a controls the speaker 11 to output a cap opening warning sound in step 10a. The cap opening warning sound may be the same sound as one of the fuel warning sound and the urea aqueous warning sound, or may be a different buzzer sound. Note that steps S2 and S3 may be omitted.

Next, the controller 10 (processor 10a that executes the notification program 10c), in step S4A, the amount of liquid (one of the fuel and the urea-water) in the tank (one of the fuel tank 25 and the urea aqueous tank 61) is measured based on a signal from the liquid amount detection sensor (one of the fuel amount detection sensor 18 and the urea-water amount detection sensor 19). The controller 10 (the processor 10a that executes the notification program 10c) measures the amount of the additional liquid (the other of the fuel and the urea-water) in the additional tank (the other of the fuel tank 25 and the urea aqueous tank 61) based on the signal from the additional liquid amount detection sensor (the other of the fuel amount detection sensor 18 and the urea-water amount detection sensor 19) in step S4B.

In step S5A, the controller 10 (the processor 10a that executes the notification program 10c) determines whether or not the amount of liquid per unit time increases. When the amount of liquid per unit time increases (Yes in step S5A), in step S6A, the controller 10 (the processor 10a that executes the notification program 10c) determines whether or not the amount of liquid exceeds a predetermined value. When the amount of the liquid exceeds the predetermined value (Yes in step S6A), the controller 10 (the processor 10a that executes the notification program 10c) controls the speaker 11 to output a warning sound in step 10a. After the end of step S7A, the process returns to step S2. When the amount of the liquid does not exceed the predetermined value (No in step S6A), in step S8A, the controller 10 (the processor 10a that executes the notification program 10c) controls the speaker 11 to output the notification sound corresponding to the amount of liquid. In step S9A, the controller 10 (the processor 10a that executes the notification program 10c) controls the indicator (one of the fuel indicator 13 and the urea aqueous indicator 14) to blink in accordance with the amount of liquid. In step S10A, the controller 10 (the processor 10a that executes the notification program 10c) controls the working light (one of the headlight 15 and the rear light 16) to blink in accordance with the amount of liquid. After the end of step S10A, the process returns to step S2.

When the amount of liquid per unit time has not increased (No in step S5A), in step S5B, the controller 10 (the processor 10a that executes the notification program 10c) determines whether or not the amount of the additional liquid per unit time has increased. When the amount of the additional liquid per unit time has not increased (No in step S5B), the process proceeds to step S11. When the amount of the additional liquid per unit time is increasing (Yes in step S5B), in step S6B, the controller 10 (the processor 10a that executes the notification program 10c) determines whether or not the amount of the additional liquid exceeds a predetermined value. When the amount of the additional liquid exceeds the predetermined threshold value (Yes in step S6B), the controller 10 (the processor 10a that executes the notification program 10c) controls the speaker 11 to output the additional warning sound in step S7B. After the end of step S7B, the process returns to step S2. When the amount of the additional liquid does not exceed the predetermined threshold value (No in step S6B), in step S8B, the controller 10 (the processor 10a which executes the notification program 10c) controls the speaker 11 to output the additional notification sound corresponding to the amount of the additional liquid. In step S9B, the controller 10 (the processor 10a that executes the notification program 10c) controls the additional indicator (the other of the fuel indicator 13 and the urea aqueous indicator 14) to blink in accordance with the amount of the additional liquid. In step S10B, the controller 10 (the processor 10a that executes the notification program 10c) controls the working light (the other of the headlight 15 and the rear light 16) to blink in accordance with the amount of the additional liquid. After the end of step S10B, the process returns to step S2.

In step S11, the controller 10 (the processor 10a that executes the notification program 10c) determines whether or not the state in which the amount of the liquid and the amount of the additional liquid do not increase continues for a predetermined time or more, or whether or not the switch 17 is pressed again. When the state in which the amount of the liquid and the amount of the additional liquid do not increase continues for a predetermined time or more, or when the switch 17 is pressed again (Yes in step S11), the controller 10 (the processor 10a that executes the notification program 10c) ends the notification program 10c in step 10c, sends a signal (power OFF signal) for switching so as not to supply electricity to the switch circuit 10d, and ends the notification program. When the state in which the amount of the liquid and the amount of the additional liquid do not increase does not continue for the predetermined time or more, or when the switch 17 is not pressed again (No in step S11), the process returns to step S2.

### Operation and Effects of Embodiment

According to an embodiment, the method of controlling the work vehicle 1 or the process performed by the controller 10 of the work vehicle 1 includes measuring the amount of liquid (one of fuel and urea aqueous) in the tank (one of the fuel tank 25 and the urea aqueous tank 61), outputting the notification sound when the amount of liquid per unit time increases, and stopping the output of the notification sound when the amount of liquid per unit time does not increase. According to this, it is possible to provide the work vehicle 1 that notifies the user of the supply of the liquid during the supply of the fuel or the urea aqueous.

### Modification

In the above-described embodiment, the work vehicle 1 notifies the liquid amount of the fuel tank 25 and the liquid amount of the urea aqueous tank 61, but may further notify the liquid amount of the hydraulic oil of the hydraulic oil tank 20. In this case, it is desirable that the work vehicle 1 outputs the hydraulic fluid replenishment notification sound in a mode that can be distinguished from the fuel replenishing notification sound and the urea-water replenishment notification sound. Alternatively, the work vehicle 1 may notify the liquid amount of the hydraulic oil in the hydraulic oil tank 20 instead of the liquid amount in the fuel tank 25 or the liquid amount in the urea aqueous tank 61. Or, the work vehicle 1 may notify any one of the liquid amount of the fuel tank 25 and the liquid amount of the urea aqueous tank 61. In this case, steps S2, S3, S4B, S5B, S6B, S7B, S8B, S9B, and S10B of FIG. 8 may be omitted. At this time, in the description of the flowchart described above, “return to step S2” may be replaced with “return to step S4A”, and when the determination result in step S5A is Yes, the process may proceed to step S11.

In this application, the word “comprise” and its derivatives are used as open-ended terms to describe the presence of elements but not to exclude the presence of other elements not listed. This applies to “having”, “including” and derivatives thereof.

The terms such as “member”, “portion”, “part”, “element”, “body”, and “structure” is intended to mean there is a single such component or a plurality of such components.

The ordinal terms such as “first” and “second” are merely used for distinguishing purposes and there is no other intention (for example, a specific order). For example, mere use of a “first element” does not connote the existence of a “second element,” otherwise the mere use of a “second element” does not connote the existence of a “first element.”

Terms of degree such as “substantially”, “about”, and “approximately” can mean a reasonable amount of deviation such that the end result is not significantly changed, unless the embodiment is specifically described otherwise. All numerical values recited herein may be construed to include terms such as “substantially,” “about,” and “approximately.”

The phrase “at least one of A and B” as used herein should be intended to be interpreted as “only A”, “only B”, or “both A and B”.

Obviously, numerous modifications and variations of the present invention are possible in light of the above teachings. Thus, it is to be understood that the invention may be practiced otherwise than as specifically described herein without departing from the scope of the invention.

What is claimed is:

1. A work vehicle comprising:
a tank configured to store a liquid;
a liquid amount detection sensor provided in the tank and configured to measure an amount of the liquid in the tank;
a speaker configured to output a notification sound; and
circuitry configured to control the speaker to output the notification sound when the amount of the liquid per unit time detected by the liquid amount detection sensor increases, the circuitry being configured to control the speaker to stop outputting the notification sound when the amount of the liquid per unit time detected by the liquid amount detection sensor does not increase.

2. The work vehicle according to claim 1, further comprising:
a display configured to display an indicator that indicates the amount of the liquid,
wherein the circuitry is configured to control the display to blink the indicator when the amount of the liquid per unit time increases, and is configured to control the display to stop blinking the indicator when the amount of the liquid per unit time does not increase.

3. The work vehicle according to claim 1, further comprising:
a working light configured to illuminate surroundings of the work vehicle,
wherein the circuitry is configured to blink the working light when the amount of the liquid per unit time increases, and is configured to stop blinking the working light when the amount of the liquid per unit time does not increase.

4. The work vehicle according to claim 1, wherein
a first characteristic of the notification sound is changed in accordance with the amount of the liquid.

5. The work vehicle according to claim 4, wherein
a warning sound is emitted when the amount of the liquid exceeds a predetermined threshold value, and
the warning sound is different from the notification sound in the first characteristic or a second characteristic that is different from the first characteristic.

6. The work vehicle according to claim 5,
wherein the first characteristic is one of a frequency spectrum in audible range and an output interval at which each of the warning sound and the notification sound is intermittently emitted, and
wherein the second characteristic is another of the frequency spectrum in audible range and the output interval.

7. The work vehicle according to claim 2, wherein
the greater the amount of the liquid is, the shorter an interval at which the indicator blinks is.

8. The work vehicle according to claim 3, wherein
the greater the amount of the liquid is, the shorter an interval at which the working light blinks is.

9. The work vehicle according to claim 6, further comprising:
an additional tank configured to store an additional liquid which is different from the liquid; and
an additional liquid amount detection sensor provided in the additional tank and configured to measure an amount of the additional liquid in the additional tank,
wherein the speaker is configured to output an additional notification sound different from the notification sound in the second characteristic, and
wherein the circuitry is configured to control the speaker to output the additional notification sound when the amount of the additional liquid per unit time detected by the additional liquid amount detection sensor increases, and is configured to control the speaker to stop the output of the additional notification sound when the amount of the liquid per unit time detected by the additional liquid amount detection sensor does not increase.

10. The work vehicle according to claim 9, further comprising:
a display configured to display an indicator that indicates an amount of the liquid and an additional indicator that indicates an amount of the additional liquid,
wherein the circuitry is configured to
control the display to blink the indicator when the amount of the liquid per unit time increases,
control the display to stop blinking of the indicator when the amount of the liquid per unit time does not increase,
control the display to blink the additional indicator when the amount of the additional liquid per unit time increases, and
control the display to stop blinking of the additional indicator when the amount of the additional liquid per unit time does not increase.

11. The work vehicle according to claim 9, further comprising:
a working light configured to illuminate surroundings of the work vehicle, and
an additional working light different from the working light and configured to illuminate surroundings of the work vehicle,
wherein the circuitry is configured to blink the working light when the amount of the liquid per unit time increases and is configured to stop blinking the working light when the amount of the liquid per unit time does not increase,
wherein the circuitry is configured to blink the additional working light when the amount of the additional liquid per unit time increases, and is configured to stop blinking the additional working light when the amount of the additional liquid per unit time does not increase.

12. The work vehicle according to claim 9, wherein
the first characteristic of the additional notification sound is changed in accordance with the amount of the additional liquid.

13. The work vehicle according to claim 12, wherein
when the additional liquid exceeds a predetermined additional threshold value, an additional warning sound different from the additional notification sound in the first characteristic or the second characteristic is emitted.

14. The work vehicle according to claim 10,
wherein the greater the amount of the liquid is, the shorter an interval at which the indicator blinks is, and
wherein the greater the amount of the additional liquid is, the shorter an interval at which the additional indicator blinks is.

15. The work vehicle according to claim 11,
wherein the greater the amount of the liquid is, the shorter an interval at which the working light blinks is, and
wherein the greater the amount of the additional liquid is, the shorter the interval at which the additional operation light blinks is.

16. The work vehicle according to claim 9,
wherein the liquid is one of a fuel and a urea aqueous, and
wherein the additional liquid is another of the fuel and the urea aqueous.

17. The work vehicle according to claim 1, further comprising:
a power supply configured to supply electricity to the circuitry; and
switching circuitry configured to switch on the circuitry by connecting the power supply to the circuitry and to switch off the circuitry by disconnecting the power supply from the circuitry,
wherein the circuitry is configured to send a signal to the switching circuitry to switch off the electricity when a predetermined time has elapsed from a state in which the amount of the liquid has not increased.

18. The work vehicle according to claim 1, wherein
the liquid amount detection sensor is a liquid level sensor to measure a liquid level of the liquid in the tank.

19. A work vehicle comprising:
a tank configured to store a liquid;
an additional tank configured to store an additional liquid which is different from the liquid;
a liquid amount detection sensor provided in the tank and configured to measure an amount of the liquid in the tank;
an additional liquid amount detection sensor provided in the additional tank and configured to measure an amount of the additional liquid in the additional tank;
a speaker configured to output a notification sound and an additional notification sound which are different from each other in one of characteristics out of a frequency spectrum in an audible range and an output interval at which each of the notification sound and the additional notification sound is intermittently emitted; and
circuitry configured to control the speaker to output the notification sound in accordance with the amount of the liquid and to control the speaker to output the additional notification sound in accordance with the amount of the additional liquid.

20. A method for detecting liquid replenishment of a work vehicle, comprising:
measuring an amount of a liquid in a tank;
outputting a notification sound when the amount of the liquid per unit time increases; and
stopping the output of the notification sound when the amount of the liquid per unit time does not increase.
